(19) United States
(12) Patent Application Publication
(10) Pub. No.: US 2019/0066137 A1
(43) Pub. Date: Feb. 28, 2019

(54) SYSTEMS AND METHODS FOR MODELING IMPACT OF COMMERCIAL DEVELOPMENT ON A GEOGRAPHIC AREA

(71) Applicant: The Chicago TREND Corporation, Chicago, IL (US)

(72) Inventors: Robert W. WEISSBOURD, Chicago, IL (US); Michael HE, Chicago, IL (US); Richard VOITH, Philadelphia, PA (US); Jonathan TANNEN, Philadelphia, PA (US); Daniel MILES, Philadelphia, PA (US)

(21) Appl. No.: 15/959,836

(22) Filed: Apr. 23, 2018

Related U.S. Application Data
(60) Provisional application No. 62/489,254, filed on Apr. 24, 2017.

(51) Int. Cl. G06Q 30/02; G06F 17/50; G06Q 10/06

(52) U.S. Cl. CPC G06Q 30/0205; G06F 2217/16; G06Q 10/067; G06F 17/5009

(57) ABSTRACT

Aspects of the present disclosure generally relate to systems and methods for modeling the impact of commercial development on a geographic area. In particular, the computer systems and methods of the present disclosure represent improved tools for modeling the impact of dynamic retail development on neighborhood characteristics and development patterns and, conversely, modeling the impact of dynamic neighborhood characteristics and development patterns on retail development, on a web-based, open-source platform. Other embodiments of related systems and methods are also provided.

Aspects of the present disclosure generally relate to systems and methods for modeling the impact of commercial development on a geographic area. In particular, the computer systems and methods of the present disclosure represent improved tools for modeling the impact of dynamic retail development on neighborhood characteristics and, conversely, modeling the impact of dynamic neighborhood characteristics on retail development, on a web-based, open-source platform.

Communities in a given geographic area, whether comprised of residential neighborhoods, commercial centers, or some combination thereof, undergo continuous transformation as a result of a number of ever-changing variables relating to demographics, accessibility, consumption characteristics, and the like. The development and sustainability of commercial, and specifically retail, outlets is heavily influenced by the type and degree of transformation experienced by such communities over a period of time. In light of such influence, community and retail developers have faced an ongoing challenge when attempting to identify what type of retail outlet (or even what specific branded retail outlet) will be successful in one or more of a number of available locations within a geographical area and, relatedly, in attempting to identify emerging markets for particular types of retail establishments. While certain retail and neighborhood analytics are useful in a variety of contexts, such analytics have not been optimized to evaluate and predict what retail outlets are likely to catalyze a change in neighborhood type and demographics, thus leading to an increased opportunity for developers (both residential and retail). Accordingly, it would be advantageous to provide an apparatus or system that allows for sophisticated and predictive market data on communities' current state and change trajectories, and the impact of retail development in the context of particular state and change trajectories, in turn enabling the identification of retail projects that can drive transformative change. To maximize accessibility and utility, such an apparatus or system should be capable of execution on a web-based and/or open-source platform.

### SUMMARY OF THE INVENTION

Among the various aspects of the present disclosure are systems and methods for modeling the impact of commercial development on a geographic area, providing analytics for evaluating the likely effect of new retail development on communities and the potential for catalyzing neighborhood and demographic change. The systems and methods of the present disclosure are designed to enable a web-based platform to support, operate, and execute code in real-time, thereby offering a technical advantage over prior methods that are inoperable on such a platform due to inherent limitations in computer memory and related data storage parameters.

Briefly, therefore, one aspect of the present disclosure is a system for measuring the impact of commercial development on a geographic area, the system comprising one or more processors and one or more memory devices operably coupled to the one or more processors, the one or more memory devices storing executable and operational code effective to cause the one or more processors to: prompt a display of a map image corresponding to a geographical area, wherein the geographical area has a population of residents; receive an identification of more than one defined geographic area within the geographical area, the defined geographic area being a commercial corridor defined through received user input associated with display of the map image; assign to each commercial corridor a population of retail outlets, each retail outlet being categorized into one or more retail groups; access a first data set comprising first units of observation, wherein each first unit of observation corresponds to a single visit by a member of the population of residents in the geographical area to a retail outlet or retail group in a commercial corridor; perform a first regression based on the first data set, the first regression comprising modeling the probability of one or more members of the population of residents visiting one or more commercial corridors, wherein the probability is based on one or more variables selected from the group consisting of demographic characteristics and commercial corridor characteristics; access a second data set comprising second units of observation, wherein each second unit of observation corresponds to a change in location in residence by a member of the population; perform a second regression based on the second data set, the second regression comprising modeling the probability of one or more members of the population of residents relocating their residence proximate to one or more commercial corridors, wherein the probability is based on one or more variables selected from the group consisting of neighborhood characteristics, demographic characteristics, and commercial corridor characteristics; identify a target commercial corridor and indicate a retail outlet or a retail group for installation in the identified target commercial corridor; access a sub-set of the first data set and a sub-set the second data set, wherein the respective data sub-sets correspond to the identified target commercial corridor; update the first data sub-set, the second data sub-set, or both the first and second data sub-sets, to reflect commercial corridor characteristics adjusted to include the retail outlet or retail group to be installed in the commercial corridor; perform a simulation based on the updated data sub-set(s), the simulation comprising either (i) modeling the probability of one or more residents visiting the target commercial corridor or at least one non-targeted commercial corridor, or (ii) modeling the probability of one or more members of the population of residents relocating their residence proximate to the target commercial corridor or proximate to at least one non-targeted commercial corridor, wherein the probability is based on one or more variables selected from the group consisting of neighborhood characteristics, demographic characteristics, and/or commercial corridor characteristics; and compare one or both of the first data set and the second data set to the updated data sub-set(s) to provide a predicted change in neighborhood characteristics, demographic characteristics, and/or commercial corridor characteristics for one or more target commercial corridor, non-targeted commercial corridor, or residential area proximate to a target or non-targeted commercial corridor, wherein the executable and operational code is compiled and run on the internet. Methods for operating such a system are also described herein.

### BRIEF DESCRIPTION OF THE DRAWINGS

To facilitate further description of the embodiments, the following drawings are provided in which:

FIG. 1 illustrates a front elevational view of an exemplary computer system that is suitable to implement at least part of a central computer system, at least part of one or more user computer systems, and/or at least part of one or more third party computer systems of the system of FIG. 3, and/or one or more other systems and methods described herein;

FIG. 2 illustrates a representative block diagram of exemplary elements included on the circuit boards inside a chassis of the computer system of FIG. 1; and

FIG. 3 illustrates a representative block diagram of a system, according to an embodiment of the present disclosure.

FIG. 4 illustrates a representative block diagram of a central computer system.

### DETAILED DESCRIPTION OF EXAMPLES OF EMBODIMENTS

Aspects of the present disclosure relate to systems and methods for measuring the impact of commercial development on a geographic area via a web-based and/or open source platform, advantageously providing analytical data that accelerates strategic retail development to drive neighborhood transformation.

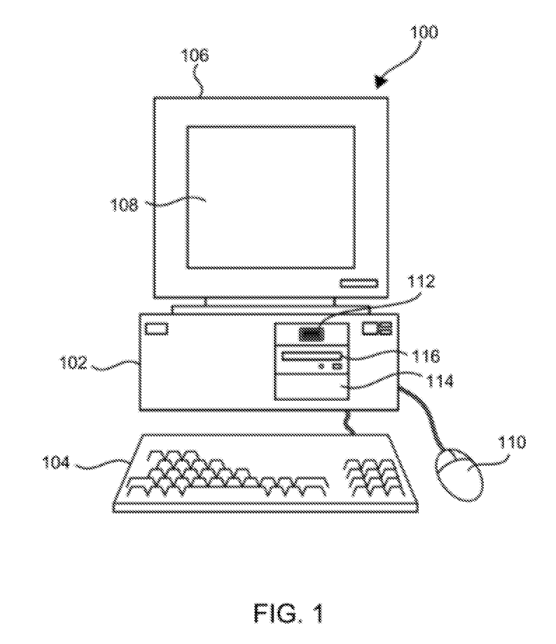

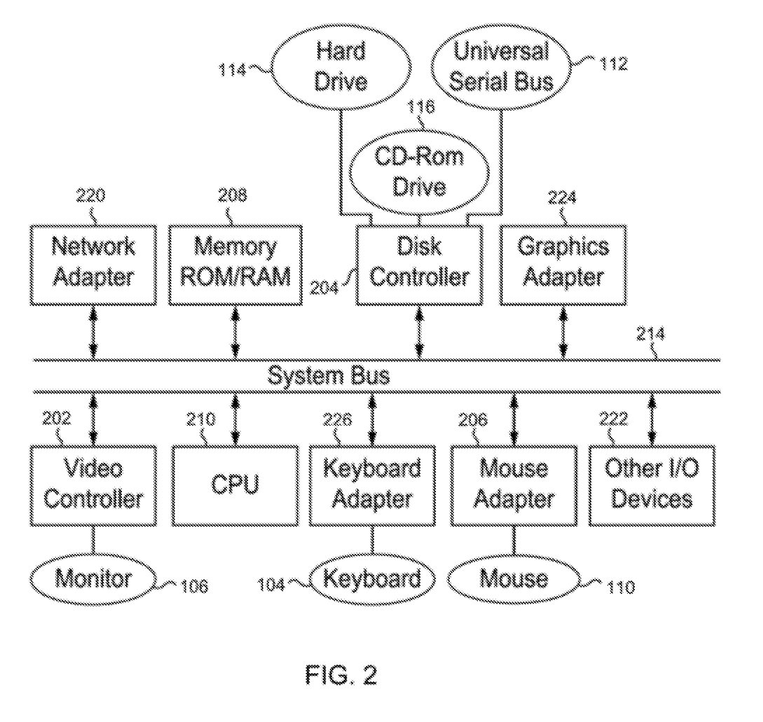

FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage devices described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a refreshing monitor 106, a keyboard 104, and/or a mouse 110, etc.) can also be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM), Digital Video Disc (DVD) drive, and/or Blu-ray drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile (e.g., non-transitory) memory, such as, for example, read only memory (ROM) and/or (ii) volatile (e.g., transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage device(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1 & 2), hard drive 114 (FIGS. 1 & 2), CD-ROM and/or DVD drive 116 (FIGS. 1 & 2), a floppy disk drive (not shown), an optical disc (not shown), a magneto-optical disc (now shown), magnetic tape (not shown), etc. Further, non-volatile or non-transitory memory storage device(s) refer to the portions of the memory storage device(s) that are non-volatile (e.g., non-transitory) memory.

In various examples, portions of the memory storage device(s) of the various embodiments disclosed herein (e.g., portions of the non-volatile memory storage device(s)) can be encoded with a boot code sequence suitable for restoring computer system 100 (FIG. 1) to a functional state after a system reset. In addition, portions of the memory storage device(s) of the various embodiments disclosed herein (e.g., portions of the non-volatile memory storage device(s)) can comprise microcode such as a Basic Input-Output System (BIOS) or Unified Extensible Firmware Interface (UEFI) operable with computer system 100 (FIG. 1). In the same or different examples, portions of the memory storage device(s) of the various embodiments disclosed herein (e.g., portions of the non-volatile memory storage device(s)) can comprise an operating system, which can be a software program that manages the hardware and software resources of a computer and/or a computer network. Meanwhile, the operating system can perform basic tasks such as, for example, controlling and allocating memory, prioritizing the processing of instructions, controlling input and output devices, facilitating networking, and managing files. Exemplary operating systems can comprise (i) Microsoft® Windows® operating system (OS) by Microsoft Corp. of Redmond, Wash., United States of America, (ii) Mac® OS by Apple Inc. of Cupertino, Calif., United States of America, (iii) UNIX® OS, and (iv) Linux® OS. Further exemplary operating systems can comprise (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States of America, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

As used herein, “processor” and/or “processing device” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing devices of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1 & 2) and mouse 110 (FIGS. 1 & 2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1 & 2) to display images on a screen 108 (FIG. 1) of computer system 100 (FIG. 1). Disk controller 204 can control hard drive 114 (FIGS. 1 & 2), USB port 112 (FIGS. 1 & 2), and CD-ROM drive 116 (FIGS. 1 & 2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage device(s) of the various embodiments disclosed herein can be executed by CPU 210 (FIG. 2). At least a portion of the program instructions, stored on these devices, can be suitable for carrying out at least part of the techniques and methods described herein. In various embodiments, computer 100 can be reprogrammed with one or more systems, applications, and/or databases to convert computer system 100 from a general purpose computer to a special purpose computer.

Further, although computer system 100 is illustrated as a desktop computer in FIG. 1, in many examples, system 100 can have a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smart phone. In certain additional embodiments, computer system 100 may comprise an embedded system.

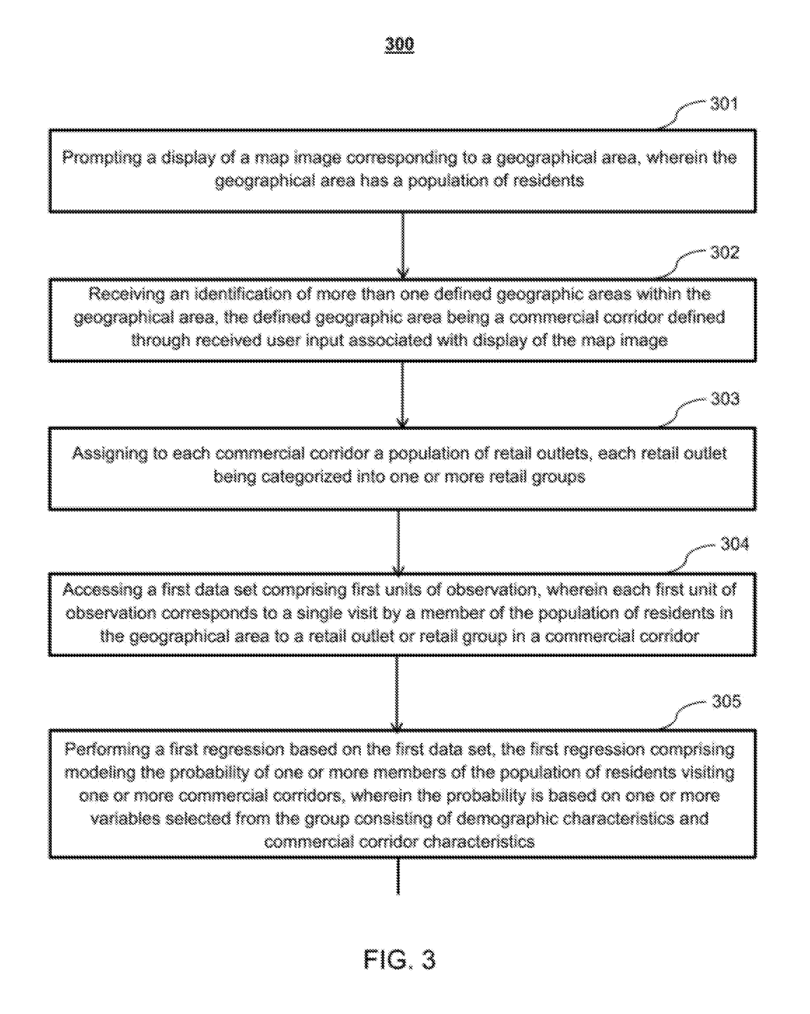

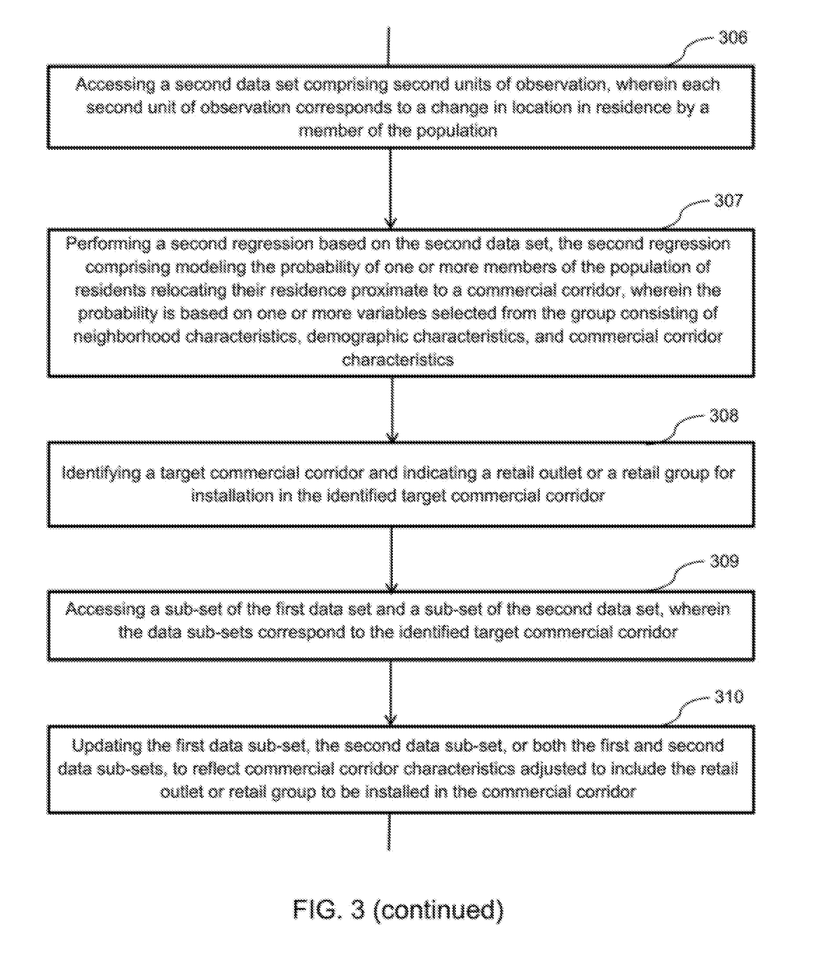

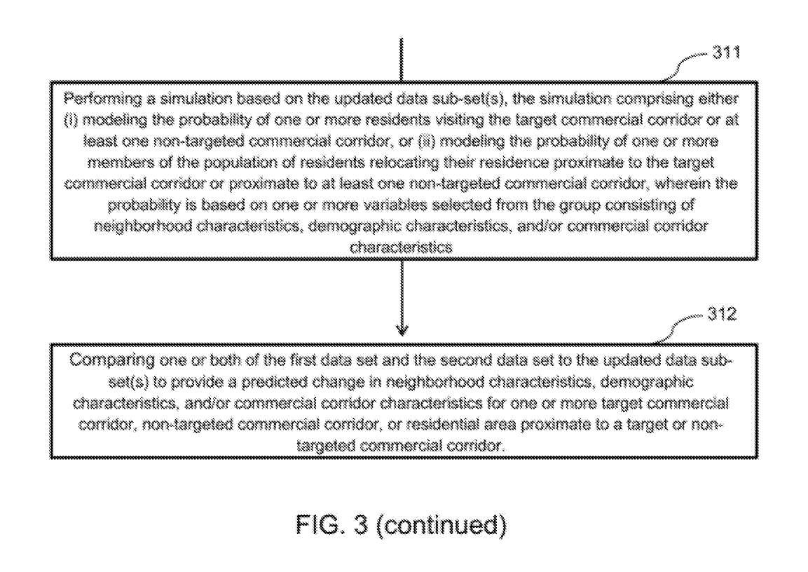

Skipping ahead now in the drawings, FIG. 3 illustrates a representative block diagram of a system 300, according to an embodiment of the present disclosure. In many embodiments, system 300 can comprise a computer system. In some embodiments, system 300 can be implemented to perform part or all of a method.

System 300 is merely exemplary and embodiments of the system are not limited to the embodiments presented herein. System 300 can be employed in many different embodiments or examples not specifically depicted or described herein. In some embodiments, certain elements of system 300 can perform various methods and/or activities of those methods. In these or other embodiments, the methods and/or the activities of the methods can be performed by other suitable elements of system 300.

As explained in greater detail below, in many embodiments, system 300 can be operable on a web-based, open-source platform to effectively predict which types of retail outlets will attract consumers/shoppers into a neighborhood, identify existing or emerging commercial corridors in or proximate to residential neighborhoods that have the greatest potential for change based on consumption habits and demographic shifts, and rank retail corridors by their attractiveness to different demographic groups. In certain embodiments, system 300 may comprise one or more analytical tools in a series of tools designed to accurately model the impact of retail development on a commercial area and residential area (i.e., neighborhood) proximate to a retail outlet, retail group (e.g., retail development area), or commercial corridor, including (1) a tool to evaluate the impact of newly-installed retail outlets on shoppers to commercial corridor(s) in a geographic area (e.g., a metropolitan area, city, municipality, or series of municipalities) and the impact of such retail outlets on demographic and other trends in residential areas (i.e., neighborhoods) proximate to the commercial corridor(s); (2) a tool to create new commercial corridors in a geographical area based on the installation of new retail outlets and/or retail groups and perform the same analysis as described in (1); and (3) a ranking tool that utilizes pre-calculated probabilities to analyze and specifically identify retail outlets or retail groups most likely to drive a change in neighborhood characteristics, demographic characteristics, and/or commercial corridor characteristics.

Referring now to the exemplary embodiment illustrated by FIG. 3, system 300 comprises an analytical tool to measure the impact of commercial development on a geographic area. In the embodiment of FIG. 3, the analytical tool is designed to evaluate the impact of commercial development (i.e., the installation of a new retail outlet and/or retail group) on a geographic area and, more specifically, to model the probability of (i) one or more members a population of residents in a geographic area (i.e., a consumer) visiting a specified commercial corridor for the purpose of engaging in retail activity (i.e., shopping), and/or (ii) one or more members of a population of residents in a geographic area relocating their residence proximate to a commercial corridor, thus altering the demographic and neighborhood characteristics of a residential area (i.e., neighborhood) proximate to an identified commercial corridor. The analytical tool may comprise one or more regression models, for example, a conditional logit regression model.

In one embodiment, the analytical tool comprises a conditional logit regression model based on one or more data sets comprising units of observation. The data set(s) utilized in the conditional logit regression model may be obtained from census data, public or private survey data, credit card data, public records from governmental entities (e.g., Bureau of Labor Statistics), and the like. In certain embodiments, the units of observation correspond to a single visit by a member of the population of residence in a geographical area to a retail outlet or retail group in a commercial corridor. In general, the target variable is a categorical variable indicating which commercial corridor in the geographical area the member of the population visited on a specified shopping trip. A unit of observation (e.g., shopping trip) selected from the data set may be mapped to a commercial corridor based on the geographic location of the retail outlet visited. The conditional logit regression may model the probability pᵢⱼ of consumer i visiting a specific commercial corridor j′ according to Formula 1:

$${η}_{{ij}^{′}} = f ( {Z}_{{j}^{′}} , {X}_{i} * {Z}_{{j}^{′}} , {X}_{{ij}^{′}} ) \\ {p}_{{ij}^{′}} = exp ( {η}_{{ij}^{′}} ) \text{/} {\sum }_{j = 1}^{J} exp ( {η}_{ij} ) \qquad Formula 1$$

where n_{ij′} is an utility function of the Commercial Corridor j′ to person i with Z_{1′} being commercial corridor characteristics, Xᵢ*Z_{j′} being the interaction between person-level demographic characteristics and commercial corridor characteristics, and X_{ij′} being characteristics defined by pairing person-level demographic characteristics with the characteristics of the commercial corridor visited; and where p_{ij′} is the exponential of the utility of the commercial corridor j′ to person i divided by the sum of exponentials of every commercial corridor to the person i. In some embodiments, the characteristics defined by Xᵢ*Z_{j′} may include, for example, the distance between the location of residence of the member of the population of the geographical area (i.e., the person) and the location of the commercial corridor of the retail outlet visited on the given shopping trip. The conditional logit regression may thus model the probability of one or more members of the population of residents visiting one or more commercial corridors, wherein the probability is based on one or more variables selected from the group of demographic characteristics, commercial corridor characteristics, or combinations thereof.

In another embodiment, the analytical tool comprises a conditional logit regression model based on one or more data sets comprising units of observation, where a unit of observation corresponds to a change in location in residence (i.e., relocation) by a member of the population to a different geographic location within the geographical area. A unit of observation reflecting the relocation may be further limited by the time period in which such a relocation occurred. In some embodiments, therefore, the unit of observation may correspond to a change in location in residence by a member of the population to a different geographic location within the geographical area, wherein such change in location may have occurred in the preceding 10 years, 9 years, 8 years, 7 years, 6 years, 5 years, 4 years, 3 years, 2 years, 1 year, six months, three months or one month from the date of data collection, and such relocation may have occurred between any two geographic locations in the geographical area or between specified geographic locations in the geographical area, where the geographical location that the member relocated to is identified as the observed choice in neighborhood. The conditional logit regression may model the member's choice in neighborhood within the geographical area according to Formula 2:

$${θ}_{{in}^{′}} = f ( {Z}_{{n}^{′}} , {X}_{i} * {Z}_{{n}^{′}} , {X}_{{in}^{′}} ) \\ {p}_{{in}^{′}} = exp ( {θ}_{{in}^{′}} ) \text{/} {\sum }_{n = 1}^{N} exp ( {θ}_{in} ) \qquad Formula 2$$

where θ_{in′} represents the utility function of consumer i relocating to a specific neighborhood n′ with Z_{n′} being neighborhood characteristics, such as socio-economic characteristics, property valuation, diversity, accessibility, and the like, which contribute to neighborhood appeal, Xᵢ*Z_{n′} being person-level demographic characteristics interacted with neighborhood characteristics, and X_{in′} being characteristics defined by pairing person-level demographic characteristics with the characteristics of the neighborhood relocated; and where p_{in′} is the exponential of the utility of neighborhood j′ to person i divided by the sum of exponentials of every neighborhood within the geographical area to the person i. In a preferred embodiment, at least one data set used to model neighborhood choice according to Formula 2 comprises at least one variable corresponding to an output of the first conditional logit regression model represented by Formula 1.

Neighborhood choice may be influenced by the attractiveness of commercial corridors proximate to (i.e., nearby) a given neighborhood. Accordingly, in certain embodiments, it is advantageous to use the shopper choice utility as an input to the neighborhood choice (e.g., the model described above, probability pᵢⱼ of consumer i visiting commercial corridor j). For example, for each pair of member (i.e., person) and possible neighborhood, it may be advantageous to determine the probability of the member visiting a retail outlet in one or more commercial corridors proximate to the neighborhood where the member could possibly relocate. That probability may be determined based on distance between the potential neighborhood and commercial corridors visited by the member; for example, utility may be based on shopper choice for the closest commercial corridor to the possible neighborhood, the two closest commercial corridors, the three closest commercial corridors, the four closest commercial corridors, the five closest commercial corridors, the six closest commercial corridors, the seven closest commercial corridors, the 10 closest commercial corridors, the 12 closest commercial corridors, or the 15 closest commercial corridors. Preferably, utility is based on the closest two, three, four, five, or six commercial corridors to the member's potential neighborhood. Most preferably, utility is based on the five commercial corridors closest to member's potential neighborhood. Mean utility may be further interacted with demographic characteristics, including income, age, race/ethnicity, education level, and presence of children, among other factors.

In some embodiments, one or both regression model(s) described above may be applied to predict changes in shopping and/or moving patterns of members of the population in a geographical area. Significantly, a combination of the two regression models described above provides for a computer system that efficiently and accurately forecasts the trajectory of a residential area (e.g., neighborhood) or commercial corridor, enables prediction of the type of retail outlet or retail group capable of catalyzing a measurable change in neighborhood and/or commercial corridor characteristics, and anticipates whether a proposed retail outlet or retail group is likely to be viable based on the change in neighborhood and/or commercial corridor characteristics. The projection tool comprising the two regression models may be initiated by identifying a target commercial corridor and indicating a retail outlet or a retail group for installation in the identified target commercial corridor. Utilizing the data used to fit the two previously-described regression models, one or more sub-set(s) of the shopper probability data (Formula 1) or the neighborhood choice data (Formula 2) may be loaded where the data sub-set(s) correspond to the identified target commercial corridor. The data sub-set(s) may subsequently be updated to reflect neighborhood characteristics, commercial corridor characteristics, or both, where such updated characteristics take into account the retail outlet or retail group to be installed in the commercial corridor. In particular, the data sub-sets may be updated to reflect a change in store counts, store densities, sales densities, and the like. In certain embodiments, the data sub-set(s) may be updated to reflect updated characteristics corresponding to the target commercial corridor, one or more non-targeted commercial corridor(s) (i.e., a commercial corridor other than the target commercial corridor), or a combination thereof.

In certain embodiments, a simulation may be performed based on the updated data sub-set(s). The simulation step may comprise (i) modeling the probability of one or more members of a population of residents of a geographical area visiting the target commercial corridor or at least one non-targeted commercial corridor, and/or (ii) modeling the probability of one or more members of the population of residents relocating their residence proximate to a commercial corridor or proximate to at least one non-targeted commercial corridor. Either or both of these probabilities may be based on one or more variables selected from the group of neighborhood characteristics, demographic characteristics, and/or commercial corridor characteristics, wherein such characteristics have been updated to reflect the new retail outlet or retail group to be installed in the area. The updated data sub-sets may then be compared to the prior (i.e., non-updated) data sets to provide a predicted change in neighborhood characteristics, demographic characteristics, and/or commercial characteristics for one or more target commercial corridor, non-targeted commercial corridor, and/or one or more residential area (e.g., neighborhood) proximate to a target or non-targeted commercial corridor.

Comparison of data sets to provide a predicted change in neighborhood, demographic, and/or commercial characteristics may be obtained by calculating a new utility (nᵢⱼ=f(Zⱼ, Xᵢ*Zⱼ, Xᵢⱼ)) for each member-corridor combination. The change in η may be equivalent to the appropriate coefficients multiplied by the change in explanatory variables (i.e., characteristics). Determining the probability of each member i selecting commercial corridor j requires calculating a new denominator to account for a change in commercial corridor, which may be done, for example, by using a first-order Taylor approximation according to the following Formula 3:

$$ln {\sum }_{{j}^{′}} exp ( {η}_{{ij}^{′}}^{′} ) = ln {\sum }_{{j}^{′}} exp ( {η}_{{ij}^{′}} ) + \frac{exp ( {η}_{{ij}^{′}} ) - exp ( {η}_{ij} )}{{\sum }_{{j}^{′}} exp ( {η}_{{ij}^{′}} )} \qquad Formula 3$$

which may thus be used to calculate p′ᵢⱼ for each member. Accuracy may be improved by weighting each member proportional to Wₙ=Cn/Sn, in which Cn is the number of households in a neighborhood (according to, for example, census data) and Sn represents the number of members of the population for whom data has been collected. Such a calculation adjusts for potential bias in the neighborhood coverage, while still assuming that members of the population for whom data has been collected are representative of the neighborhood population. Overall change in neighborhood and/or commercial corridor may be determined by aggregating the marginal change calculated for each individual member; that is, determining the sum of Wₙ p′ᵢⱼ for all members, in which ηᵢ is the neighborhood in which the member i lives, to calculate the new visits to the commercial corridor in which the new retail outlet or retail group is to be installed. Similar calculations may be performed to determine which neighborhood is most likely to benefit from the addition of a retail outlet or retail group in a target commercial corridor.

In some embodiments, the simulation performed to provide a predicted change in neighborhood characteristics, demographic characteristics, and/or commercial corridor characteristics may be projected over a period of time (e.g., months or years). More specifically, it may be advantageous to predict a probability of change in the number of visits by a member of the population of residents in a geographical area to one or more retail outlet(s), retail group(s), target commercial corridor, or non-targeted commercial corridor(s), based on installation of a retail outlet or retail group in a target commercial corridor. Such predicted probability may result in an output comprising a quantity of predicted total members of the population in a residential area proximate to a target commercial corridor or one or more non-targeted commercial corridor(s) in the geographic area. In certain embodiments, the probability may be projected over a period of one year, two years, three years, four years, five years, eight years, ten years, twelve years, fifteen years, or longer.

The tools described in the preceding embodiments may be further modified to provide a user with additional metrics in which to evaluate neighborhood and/or commercial corridor trajectory, retail outlets likely to catalyze neighborhood and/or commercial corridor revitalization, and potential viability of retail outlets in particular geographical areas. For example, one embodiment of the computer system described herein may allow the user to click on an interactive map and select a location for a new commercial corridor, which preferably does not overlap with any existing or previously-defined commercial corridor. The computer system may be capable of creating a complete dataset for the new commercial corridor based on its geographic location, which then may be applied to predict shopper choice and neighborhood choice according to the models described above. In some embodiments, the initial user interface that allows for selection of input criteria may comprise a two-dimensional or three-dimensional interactive map, a table or series of tables (e.g., Microsoft Office Excel table(s)), or a combination of maps and tables.

Yet another embodiment of the computer system according to the present disclosure may provide ranking tables, which may utilize pre-calculated impacts by adding one or more types of retail outlet(s) to one or more commercial corridor(s). Such a tool may filter, average, and sort data results to provide a variety of tables. In some embodiments, the system may provide a current status table and a table of predicted changes upon the installation of a new retail outlet or retail group. Ranking tables may provide predictive models representing one or more of the following: (1) suitable retail outlets or retail groups for a given commercial corridor; (2) suitable retail outlets or retail groups for a given commercial corridor and a given neighborhood; (3) suitable commercial corridors in which to install a given retail outlet; (4) suitable commercial corridors in which to install a given retail outlet considering the impact on a given neighborhood; and (5) neighborhoods on a trajectory indicating a high probability of change.

In certain embodiments, a “commercial corridor” may be defined as a geographic area or a portion of a geographic area comprising a population of retail outlets, where each retail outlet may optionally be categorized into one or more retail groups. In some embodiments, a commercial corridor may comprise at least one retail outlet. In other embodiments, a commercial corridor may comprise at least two retail outlets. In yet other embodiments, a commercial corridor may comprise at least three retail outlets. In yet other embodiments, a commercial corridor may be arbitrarily defined and need not comprise any retail outlets. A retail outlet refers to a store where goods are sold to individual consumers or groups of consumers, and may refer to a specific individual retailer, for example, a brand-name retailer. Retail outlets, as that term is referred to in the present disclosure, may include pharmacies, convenience stores, fast food restaurants, personal service operations, grocery stores, department stores, big box stores, boutiques, restaurants, entertainment providers (e.g., movie theatres), and the like. Retail outlets may be categorized into retail groups such as pharmacy, chain pharmacy, convenience store, fast food restaurants, personal service, grocery, chain grocery, high-end grocery, department store, discount department store, big box store, restaurant and entertainment, among others. Commercial corridor(s) may be characterized by transportation accessibility, number of bus routes, rail routes and/or highways, preferred mode of transportation, store counts, store density, sales density, sales per store, commercial corridor location, area (e.g., square miles), restaurant sales, and retail sales.

In some embodiments, neighborhood characteristics may refer to one or more of socio-economic characteristics in a defined neighborhood or geographic area such as total population, population density, race composition, income composition, combined income and age composition, percentage of households with children, average weighted employment, school quality, and acres of park per person; property valuation in the defined neighborhood or geographic area; diversity, crime rates, and accessibility of the neighborhood or geographic area; and/or distance of the neighborhood or geographic area from an urban center, commercial corridor(s), and/or other neighborhoods or geographic areas. In certain other embodiments, neighborhood characteristics may refer to socio-economic conditions, property valuation, diversity, crime statistics, distance from commercial corridors, and transit accessibility, as applicable to the defined neighborhood and/or geographic area.

In some embodiments, demographic characteristics may refer to one or more of race, ethnicity, income or income range (e.g., less than $15,000, $15,000-24,999, $25,000-$34,999, $35,000-$49,999, $50,000-$74,999, $75,000-$99,999, etc.), education level, age or age range, presence of children in the household, home ownership status, car ownership status, and the like.

In some embodiments, a geographical area refers to a location on the surface of the earth defined by latitudinal and/or longitudinal coordinates, natural or artificial boundaries or landmarks, or any other boundary. In certain preferred embodiments, a geographical area comprises a metropolitan area, a city, a municipality, or a series of adjacent municipalities, and may include an urban center alone or in combination with surrounding sub-urban and/or rural regions.

In certain embodiments, a system of measuring the impact of commercial development on a geographic area as described herein may be built on an open source platform that is capable of being compiled and run over the internet. In such an embodiment, it may be desirable to run a first regression based on shopper choice data (e.g., Formula 1) and a second regression based on neighborhood choice data (e.g., Formula 2), storing the output(s) of the first regression, the second regression, or the first and second regressions on a computer processor. Where one or more regression(s) is performed and stored for later access to address memory constraints or otherwise, a simulation providing a predicted change in neighborhood, demographic, and/or commercial characteristics in accordance with Formula 3 may be run in real-time.

In other embodiments designed to operate on a web-based, open-source platform, and as explained elsewhere herein, system 300 may overcome technical shortcomings in memory storage devices by pre-calculating and storing shopper choice data, neighborhood choice data, or more granular constituents of shopper choice or neighborhood choice data (e.g., weights assigned to units of observation or distances between neighborhoods and commercial corridors), where such data may be accessed only when required to generate a prediction corresponding to a user request to measure the impact of commercial development on a geographic area. In other words, system 300 may access one or more data sets (i.e., stored values) corresponding to a neighborhood, corridor, or combination of neighborhood(s) and corridor(s) comprising the subject of a user request, but refrain from accessing one or more data sets that are irrelevant to the user request. Accordingly, use of pre-calculated data or stored values provides technical advantages (e.g., faster search times and smaller memory requirements) that improve the functioning of a computer by enabling a web-based system that operates and executes code in a manner required to implement the modeling tools of the present disclosure.

Generally, system 300 can be implemented with hardware and/or software, as described herein. In some embodiments, at least part of the hardware and/or software can be conventional, while in these or other embodiments, part or all of the hardware and/or software can be customized (e.g., optimized) for implementing part or all of the functionality of system 300 described herein.

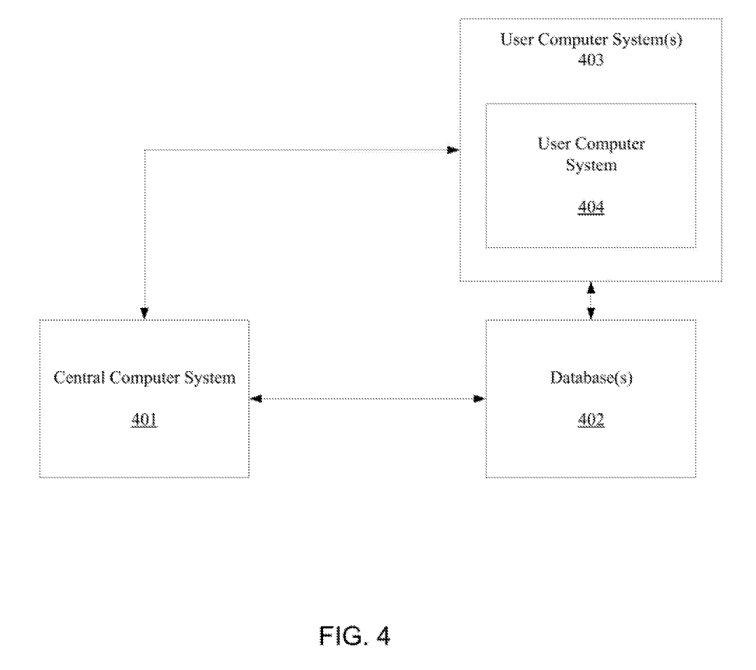

Specifically, system 300 can comprise a central computer system 401 (FIG. 4). In many embodiments, central computer system 401 can be similar or identical to computer system 100 (FIG. 1). Accordingly, central computer system 401 can comprise one or more processing devices and one or more memory storage devices (e.g., one or more non-transitory memory storage devices). In these or other embodiments, the processing device(s) and/or the memory storage device(s) can be similar or identical to the processing device(s) and/or memory storage device(s) (e.g., non-transitory memory storage devices) described above with respect to computer system 100 (FIG. 1). In some embodiments, central computer system 401 can comprise a single computer or server, but in many embodiments, central computer system 401 comprises a cluster or collection of computers or servers and/or a cloud of computers or servers. Meanwhile, central computer system 401 can comprise one or more input devices (e.g., one or more keyboards, one or more keypads, one or more pointing devices such as a computer mouse or computer mice, one or more touchscreen displays, etc.), and/or can comprise one or more output devices (e.g., one or more monitors, one or more touch screen displays, one or more speakers, etc.). Accordingly, the input device(s) can comprise one or more devices configured to receive one or more inputs and/or the output device(s) can comprise one or more devices configured to provide (e.g., present, display, emit, etc.) one or more outputs. For example, in these or other embodiments, one or more of the input device(s) can be similar or identical to keyboard 104 (FIG. 1) and/or a mouse 110 (FIG. 1). Further, one or more of the output device(s) can be similar or identical to refreshing monitor 106 (FIG. 1) and/or screen 108 (FIG. 1). The input device(s) and the output device(s) can be coupled to the processing device(s) and/or the memory storage device(s) of central computer system 401 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the output device(s) to the processing device(s) and/or the memory storage device(s). In some embodiments, the KVM switch also can be part of central computer system 401. In a similar manner, the processing device(s) and the memory storage device(s) can be local and/or remote to each other.

In many embodiments, central computer system 401 is configured to communicate with one or more user computer systems 403 (e.g., a user computer system 404) of one or more users of system 300. For example, the user(s) can interface (e.g., interact) with central computer system 401, and vice versa, via user computer system(s) 403. In some embodiments, system 300 can comprise user computer system(s) 403.

In many embodiments, central computer system 401 can refer to a back end of system 300 operated by an operator and/or administrator of system 300. In these or other embodiments, the operator and/or administrator of system 300 can manage central computer system 401, the processing device(s) of central computer system 401, and/or the memory storage device(s) of central computer system 401 using the input device(s) and/or output device(s) of central computer system 401.

Like central computer system 401, user computer system(s) 403 each can be similar or identical to computer system 100 (FIG. 1), and in many embodiments, each of user computer system(s) 403 can be similar or identical to each other. In many embodiments, user computer system(s) 403 can comprise one or more desktop computer devices, one or more wearable user computer devices, and/or one or more mobile devices, etc. At least part of central computer system 401 can be located remotely from user computer system(s) 403.

In some embodiments, a mobile device can refer to a portable electronic device (e.g., an electronic device easily conveyable by hand by a person of average size) with the capability to present audio and/or visual data (e.g., images, videos, music, etc.). For example, a mobile device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can comprise a volume and/or weight sufficiently small as to permit the mobile device to be easily conveyable by hand. For examples, in some embodiments, a mobile device can occupy a volume of less than or equal to approximately 189 cubic centimeters, 244 cubic centimeters, 1790 cubic centimeters, 2434 cubic centimeters, 2876 cubic centimeters, 4056 cubic centimeters, and/or 5752 cubic centimeters. Further, in these embodiments, a mobile device can weigh less than or equal to 3.24 Newtons, 4.35 Newtons, 15.6 Newtons, 17.8 Newtons, 22.3 Newtons, 31.2 Newtons, and/or 44.5 Newtons.

Exemplary mobile devices can comprise, but are not limited to, one of the following: (i) an iPod®, iPhone®, iPod Touch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia®, Surface Pro™, or similar product by the Microsoft Corporation of Redmond, Wash., United States of America, and/or (iv) a Galaxy™ Galaxy Tab™, Note™ or similar product by the Samsung Group of Samsung Town, Seoul, South Korea. Further, in the same or different embodiments, a mobile device can comprise an electronic device configured to implement one or more of (i) the iOS™ operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by Google, Inc. of Mountain View, Calif., United States, (v) the Windows Mobile™, Windows Phone™ and Windows 10 (mobile)™ operating systems by Microsoft Corporation of Redmond, Wash., United States of America, or (vi) the Symbian™ operating system by Nokia Corp. of Keilaniemi, Espoo, Finland.

Meanwhile, in many embodiments, central computer system 401 also can be configured to communicate with one or more search content databases 402 (e.g., one or more question databases, one or more answer databases, etc.). Search content database(s) 402 can be stored on one or more memory storage devices (e.g., non-transitory memory storage device(s)), which can be similar or identical to the one or more memory storage device(s) (e.g., non-transitory memory storage device(s)) described above with respect to computer system 100 (FIG. 1). Also, in some embodiments, for any particular database of search content database(s) 402, that particular database can be stored on a single memory storage device of the memory storage device(s) and/or the non-transitory memory storage device(s) storing search content database(s) 402 or it can be spread across multiple of the memory storage device(s) and/or non-transitory memory storage device(s) storing search content database(s) 402, depending on the size of the particular database and/or the storage capacity of the memory storage device(s) and/or non-transitory memory storage device(s).

In these or other embodiments, the memory storage device(s) of central computer system 401 can comprise some or all of the memory storage device(s) storing search content database(s) 402. In further embodiments, some of the memory storage device(s) storing search content database(s) 402 can be part of one or more of user computer system(s) 403 and/or one or more third-party computer systems (i.e., other than central computer system 401 and/or user computer system(s) 403), and in still further embodiments, all of the memory storage device(s) storing search content database(s) 402 can be part of one or more of user computer system(s) 403 and/or one or more of the third-party computer system(s). Like central computer system 401 and/or user computer system(s) 403, when applicable, each of the third-party computer system(s) can be similar or identical to computer system 100 (FIG. 1). Notably, the third-party computer systems are not shown at FIG. 3 in order to avoid unduly cluttering the illustration of FIG. 3, and search content database(s) 402 are illustrated at FIG. 3 apart from central computer system 401 and user computer system(s) 403 to better illustrate that search content database(s) 402 can be stored at memory storage device(s) of central computer system 401, user computer system(s) 403, and/or the third-party computer system(s), depending on the manner in which system 300 is implemented.

Search content database(s) 402 each can comprise a structured (e.g., indexed) collection of data and can be managed by any suitable database management systems configured to define, create, query, organize, update, and manage search content database(s). Exemplary database management systems can include MySQL (Structured Query Language) Database, PostgreSQL Database, Microsoft SQL Server Database, Oracle Database, SAP (Systems, Applications, & Products) Database and IBM DB2 Database.

Meanwhile, communication between central computer system 401, user computer system(s) 403, the third-party computer system(s), and/or search content database(s) 402 can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Data Over Cable Service Interface Specification (DOCSIS), Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.

Although the invention has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-3 may be modified, and that the foregoing discussion of certain of these embodiments does not necessarily represent a complete description of all possible embodiments. For example, one or more of the activities of method 300 (FIG. 3) or one or more of the other methods described herein may include different activities and be performed by many different elements, in many different orders. As another example, the elements within central computer system 401 and/or user computer system(s) 403 in FIG. 3 can be interchanged or otherwise modified.

Generally, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system for measuring the impact of commercial development on a geographic area, the system comprising:
one or more processors and one or more memory devices operably coupled to the one or more processors, the one or more memory devices storing executable and operational code effective to cause the one or more processors to:
prompt a display of a map image corresponding to a geographical area, wherein the geographical area has a population of residents;
receive an identification of more than one defined geographic area within the geographical area, the defined geographic area being a commercial corridor defined through received user input associated with display of the map image;
assign to each commercial corridor a population of retail outlets, each retail outlet being categorized into one or more retail groups;
access a first data set comprising first units of observation, wherein each first unit of observation corresponds to a single visit by a member of the population of residents in the geographical area to a retail outlet or retail group in a commercial corridor;
perform a first regression based on the first data set, the first regression comprising modeling the probability of one or more members of the population of residents visiting one or more commercial corridors, wherein the probability is based on one or more variables selected from the group consisting of demographic characteristics and commercial corridor characteristics;
access a second data set comprising second units of observation, wherein each second unit of observation corresponds to a change in location in residence by a member of the population;
perform a second regression based on the second data set, the second regression comprising modeling the probability of one or more members of the population of residents relocating their residence proximate to one or more commercial corridors, wherein the probability is based on one or more variables selected from the group consisting of neighborhood characteristics, demographic characteristics, and commercial corridor characteristics;
identify a target commercial corridor and indicate a retail outlet or a retail group for installation in the identified target commercial corridor;
access a sub-set of the first data set and a sub-set the second data set, wherein the respective data sub-sets correspond to the identified target commercial corridor;
update the first data sub-set, the second data sub-set, or both the first and second data sub-sets, to reflect commercial corridor characteristics adjusted to include the retail outlet or retail group to be installed in the commercial corridor;
perform a simulation based on the updated data sub-set(s), the simulation comprising either (i) modeling the probability of one or more residents visiting the target commercial corridor or at least one non-targeted commercial corridor, or (ii) modeling the probability of one or more members of the population of residents relocating their residence proximate to the target commercial corridor or proximate to at least one non-targeted commercial corridor, wherein the probability is based on one or more variables selected from the group consisting of neighborhood characteristics, demographic characteristics, and/or commercial corridor characteristics; and
compare one or both of the first data set and the second data set to the updated data sub-set(s) to provide a predicted change in neighborhood characteristics, demographic characteristics, and/or commercial corridor characteristics for one or more target commercial corridor, non-targeted commercial corridor, or residential area proximate to a target or non-targeted commercial corridor, wherein the executable and operational code is compiled and run on the internet.

2. The system of claim 1, wherein the geographical area is a metropolitan area, city, municipality, or series of adjacent municipalities.

3. The system of claim 1, wherein the population of retail outlets in more than one commercial corridor in the geographical area comprises at least 2 retail outlets.

4. The system of claim 1, wherein the population of retail outlets in more than one commercial corridor in the geographical area comprises at least 4 retail outlets.

5. The system of claim 1, wherein the one or more retail groups for categorizing the retail outlets comprises pharmacy, chain pharmacy, convenience store, fast food restaurants, personal service, grocery, chain grocery, high-end grocery, department store, discount department store, big box store, restaurant and entertainment.

6. The system of claim 1, wherein the demographic characteristics comprise race, ethnicity, age range, income level, and presence of children.

7. The system of claim 1, wherein the corridor characteristics comprise one or more of transportation accessibility, store density, sales density, commercial corridor location, restaurant sales, and retail sales.

8. The system of claim 1, wherein the neighborhood characteristics comprise one or more of socio-economic conditions, property valuation, diversity, crime statistics, distance from commercial corridors, and transit accessibility.

9. The system of claim 8, wherein the socio-economic conditions comprise one or more of total population, population density, race composition, income composition, age composition, percentage of households with children, violence rate, average weighted employment, school quality, and acres of park per person.

10. The system of claim 1, wherein the first regression is a conditional logit regression.

11. The system of claim 1, wherein the second regression is a conditional logit regression.

12. The system of claim 1, wherein the simulation comprises modeling the probability of one member or a group of members of the population of residents relocating their residence proximate to the target commercial corridor or a non-targeted commercial corridor in the next five years.

13. The system of claim 12, wherein the simulation comprises modeling the probability of a group of members of the population of residents relocating their residence proximate to the target commercial corridor in the next five years.

14. The system of claim 1, wherein the comparison of the first data set, the second data set, and the updated data sub-set(s) provides a prediction comprising a probability of a change in population in a residential area proximate to a commercial corridor, based on installation of a retail outlet or retail group in the target commercial corridor.

15. The system of claim 1, wherein the comparison of the first data set, the second data set, and the updated data sub-set(s) provides a prediction comprising a probability of change in the number of visits by a member of the population of residents in the geographical area to at least one of a retail outlet, retail group, or commercial corridor, based on installation of a retail outlet or retail group in the target commercial corridor.

16. The system of claim 1, wherein the comparison of the first data set, the second data set, and the updated data sub-set(s) provides a prediction comprising a quantity of predicted total members of the population in a residential area proximate to the target commercial corridor or one or more non-targeted commercial corridor in the geographic area.

17. The system of claim 15, wherein the population of residents in the geographical area comprises a demographic subgroup, the demographic subgroup comprising members of the population of residents in the geographical area having one or more demographic characteristics.

18. The system of claim 14, wherein the probability is projected over a five-year period.

19. The system of claim 14, wherein the probability is projected over an eight-year period.

20. The system of claim 14, wherein the probability is projected over a ten-year period.

21. The system of claim 1, wherein the second data set further comprises at least one variable corresponding to an output of the first regression.

22. The system of claim 1, wherein at least one output of the first regression and at least one output of the second regression are stored on the processor.

23. The system of claim 22, wherein the simulation is performed in real-time.

24. The system of claim 1, the executable and operational code being open source.

25. A method for operating the system of claim 1.

26. A method for measuring the impact of commercial development on a geographic area, the method comprising:
prompting a display of a map image corresponding to a geographical area, wherein the geographical area has a population of residents;
receiving an identification of more than one defined geographic area within the geographical area, the defined geographic area being a commercial corridor defined through received user input associated with display of the map image;
assigning to each commercial corridor a population of retail outlets, each retail outlet being categorized into one or more retail groups;
accessing a first data set comprising first units of observation, wherein each first unit of observation corresponds to a single visit by a member of the population of residents in the geographical area to a retail outlet or retail group in a commercial corridor;
performing a first regression based on the first data set, the first regression comprising modeling the probability of one or more members of the population of residents visiting one or more commercial corridors, wherein the probability is based on one or more variables selected from the group consisting of demographic characteristics and commercial corridor characteristics;
accessing a second data set comprising second units of observation, wherein each second unit of observation corresponds to a change in location in residence by a member of the population;
performing a second regression based on the second data set, the second regression comprising modeling the probability of one or more members of the population of residents relocating their residence proximate to one or more commercial corridors, wherein the probability is based on one or more variables selected from the group consisting of neighborhood characteristics, demographic characteristics, and commercial corridor characteristics;
identifying a target commercial corridor and indicate a retail outlet or a retail group for installation in the identified target commercial corridor;
accessing a sub-set of the first data set and a sub-set the second data set, wherein the respective data sub-sets correspond to the identified target commercial corridor;
updating the first data sub-set, the second data sub-set, or both the first and second data sub-sets, to reflect commercial corridor characteristics adjusted to include the retail outlet or retail group to be installed in the commercial corridor;
performing a simulation based on the updated data sub-set(s), the simulation comprising either (i) modeling the probability of one or more residents visiting the target commercial corridor or at least one non-targeted commercial corridor, or (ii) modeling the probability of one or more members of the population of residents relocating their residence proximate to the target commercial corridor or proximate to at least one non-targeted commercial corridor, wherein the probability is based on one or more variables selected from the group consisting of neighborhood characteristics, demographic characteristics, and/or commercial corridor characteristics; and
comparing one or both of the first data set and the second data set to the updated data sub-set(s) to provide a predicted change in neighborhood characteristics, demographic characteristics, and/or commercial corridor characteristics for one or more target commercial corridor, non-targeted commercial corridor, or residential area proximate to a target or non-targeted commercial corridor,
wherein the operational and executable code is compiled and run on the internet.

27. The method of claim 26, wherein the second data set further comprises at least one variable corresponding to an output of the first regression.

28. The method of claim 26, wherein at least one output of the first regression and at least one output of the second regression are stored on the processor.

29. The method of claim 28, wherein the simulation is performed in real-time.

30. The method of claim 26, the executable and operational code being open source.
